(19) United States
(12) Patent Application Publication
(10) Pub. No.: US 2004/0177167 A1
(43) Pub. Date: Sep. 9, 2004

(54) Network audio systems

(76) Inventors: Ryuichi Iwamura, San Diego, CA (US); David A. Desch, Poway, CA (US); Takaaki Ota, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/379,626

(22) Filed: Mar. 4, 2003

(51) Int. Cl. G06F 15/16

(52) U.S. Cl. 709/253

(57) ABSTRACT

According to one embodiment of the invention, a system is provided which includes a server and one or more clients that are connected to the server via one or more power lines. The server stores audio data recorded on multiple recording units (e.g., CDs) and corresponding information associated with the respective audio data (e.g., title, author, content list, etc.). The one or more clients access the server via the one or more power lines to download selected audio data and the corresponding information from the server.

### FIELD

An embodiment of the invention relates to the field of audio systems, networking and client/server technologies, and more specifically, relates to a method, apparatus, and system for improving network audio systems.

### BACKGROUND

In recent years, electronic and computer systems' performance and capabilities have continued to advance rapidly in light of various technological advances and improvements in audio/video processing, networking, client server technologies, etc. In particular, in the field of audio systems, several audio server products have been made available on the market. For example, one of these audio sever products is Sony DMT-PR1 Bitplay audio/video system made by Sony Corporation.

In an audio server system, the audio data on a compact disc (CD) is compressed and stored onto an internal hard disk drive (HDD). A typical HDD can record more than 300 CDs. The user selects a CD title or a song from an index list as he or she uses a jukebox. The audio server has a CD database that can store information for a large number of CDs (e.g., more than 80,000 CDs). The server automatically detects an ID recorded on the CD and the associated data (e.g., title, author, content list, etc.) is obtained or retrieved from the database. The user does not have to input such data. The CD database can be renewed or updated by downloading a new version from the Internet or by a CDROM provided by the vendor. An audio server as described above typically has an Ethernet port. A client PC can download and decode audio data from the server through a local area network such as the Ethernet.

Such a system configuration has some disadvantages. For instance, a network cable cannot be easily run from room to room. Wireless networks (e.g., IEEE 802.11 wireless networks) can provide better access, but the range of communication is substantially limited. Furthermore, wireless networks are vulnerable to noise and interference such as noise emitted by a microwave oven. In addition, normally, a client device is a personal computer (PC), which is large and expensive. The PC is also not portable. Thus, it is difficult for the user to move the PC from one location to another location.

Accordingly, there exists a need for a better network audio system that can provide the users with at least more accessibility and more mobility.

### BRIEF DESCRIPTION OF THE DRAWINGS

The invention may best be understood by referring to the following description and accompanying drawings that are used to illustrate embodiments of the invention. In the drawings:

FIG. 1 shows a block diagram of a network audio system in accordance with one embodiment of the invention;

FIG. 2 illustrates a block diagram of an exemplary server according to one embodiment of the invention;

FIG. 3 illustrates a block diagram of an exemplary client according to one embodiment of the invention;

FIG. 4 shows an example of a remote commander with an LCD display, in accordance with one embodiment of the invention; and

FIG. 5 illustrates a flow diagram of a method in accordance with one embodiment of the invention.

### DETAILED DESCRIPTION

In the following detailed description numerous specific details are set forth. However, it is understood that embodiments of the invention may be practiced without these specific details. It is appreciated that the operations described below can be performed by hardware and/or software being executed. Normally, the software is stored in a computer-readable medium such as a programmable electronic circuit, a semiconductor memory device (e.g., random access memory “RAM”, read-only memory “ROM”, flash memory, etc.), a floppy diskette, an optical disk such as a compact disk (CD) or digital versatile disc (DVD), or a hard drive disk.

### I General Architecture—Power Line Communication (PLC)

In one embodiment, a novel network audio system as described herein uses power line communication technology (PLC) to allow more convenient, flexible and cost-effective access to an audio server from various clients connected to the audio server via power lines. In addition, the use of power line communication technology enhances the mobility of the clients as they can be easily moved from one physical location to another physical location without disrupting the network configuration and the accessibility to the audio server. PLC may be deployed in accordance with the “HomePlug 1.0 Specification,” dated Jun. 30, 2001. For more information concerning the power line communication technology, please see www.homeplug.com.

The use of PLC in network audio systems provides various advantages including the following:

(1) No new cable is required. Existing power lines are used for connection between the various clients and the server.

(2) Payload transmission speed of the current PLC is already about 2 to 5 mega bits per second (Mbps). Linear CD (uncompressed) rate is about 1.2 Mbps. Compressed audio data rate is 100 to 300 kbps. Therefore, PLC speed is sufficiently fast for audio data transmission in a network audio system.

(3) The use of PLC in network audio systems is less expensive than wireless network because no antenna and no tuner are required.

(4) Generally, every room in a house or a building has power (AC) outlets. Therefore, a user of a network audio system using PLC can go to different locations in the house or the building and still be able to get connected to the system and access the audio server.

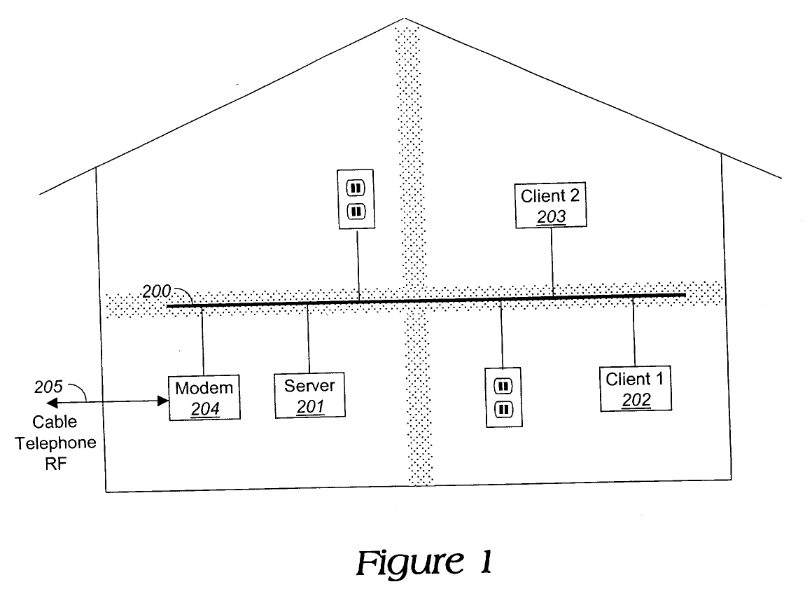

FIG. 1 illustrates a block diagram of an exemplary audio system configuration 100, in accordance with one embodiment of the invention. System 100 includes a server (also called an “audio server” herein) 201 and one or more clients (e.g., client 202 and client 203). Server 201 and clients 202 and 203 are connected and configured to transfer information over a power line 200.

In one embodiment, server 201 is configured to store audio data recorded from a large number of recording units (e.g., hundreds of CDs). Server 201 also stores other types of descriptive information associated with the audio data recorded on each recording unit such as, for example, title, author, content list, etc. This descriptive information is stored in a database.

In one embodiment, clients 202 and 203 can access server 201 via power line 200 to download and decode audio data that the user wants to listen to. Clients 202 and 203 can select and receive different streams of audio data that are stored on server 201. For example, a user can select audio data (e.g., one or more songs) stored on server 201 from a particular CD using the title of the CD, titles of the songs, etc. Accordingly, one user at one location in a household is able to connect to server 201, download audio data and listen to a selected type of music (e.g., classical) while another user at a different location can connect to server 201 and enjoy a different type of music.

Client 202 and 203 may decode the audio stream received from server 201. In this system configuration, according to one embodiment of the invention, a user can listen to the same music even if he or she moves to another room. The structure and operations of server 201 and the clients (e.g., client 202 and 203) are described in more details below. As shown in FIG. 1, system 100 further includes a modem (e.g., cable, telephone or xDSL) 204 coupled to power line 200 and transmission medium 205 (e.g., telephone line, radio frequency “RF” signal, cable, etc.). In one embodiment, the various components of the system 100 (e.g., server 201, clients 202 and 203) can communicate with other external systems and networks (e.g., external systems or servers that are accessible through the Internet) via modem 204 and transmission medium 205.

A. Server

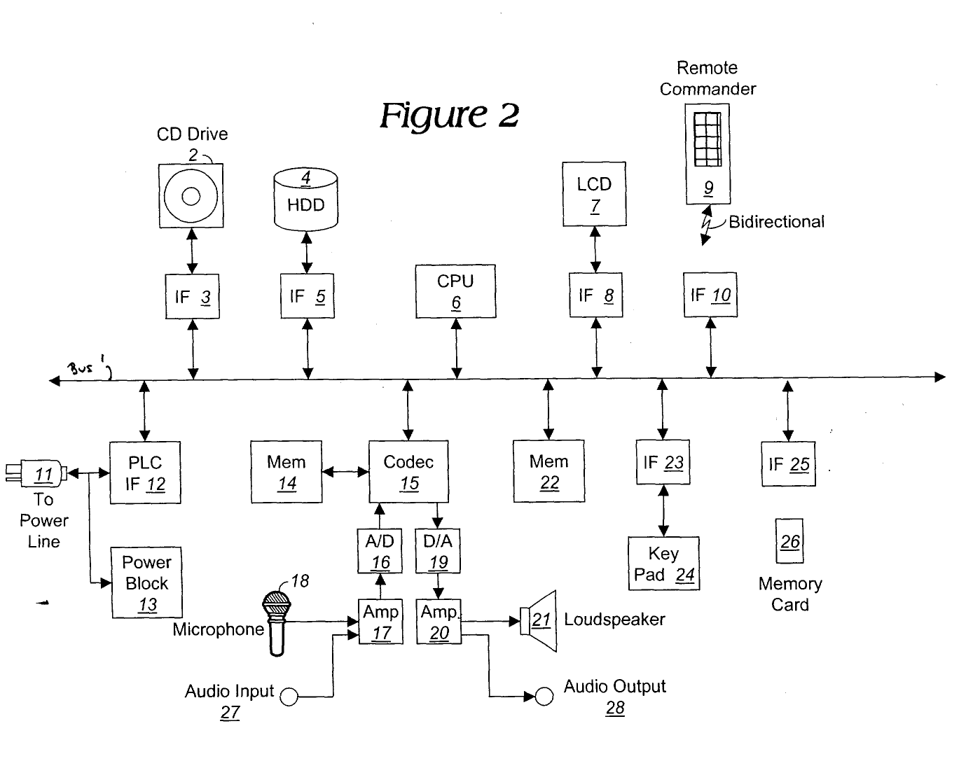

FIG. 2 shows an exemplary block diagram of server 201 in accordance with one embodiment of the invention. As shown in FIG. 2, server 201 comprises a central processing unit (CPU) 6, a CD drive 2, a hard disk drive (HDD) 4, and a user interface 7 (e.g., an LCD, a touch screen device, or other types of graphical user interfaces, etc.) CPU 6 controls all the components through a bus 1 (referred to as “Bus”). In one embodiment, the control software program for CPU 6 is stored in memory 22. Power plug 11 is connected to PLC Interface (IF) 12 and power block 13. In one embodiment, PLC IF 12 is configured to receive only high frequency signals on power line 200 through an isolation transformer (not shown). Power block 13 can be, for example, a switching regulator. It supplies DC power to each component.

1. Storing CD Data to HDD

In one embodiment, a user can store data from a recording unit (e.g., a CD) to HDD 4 of server 201 as follows. The user sets the CD on CD drive 2. CD Drive 2 reads the unique ID number of the CD and sends it to CPU 6 through a first interface (IF) 3 and Bus 1. In one embodiment, the CD database is located in HDD 4. Using the unique ID number, CPU 6 queries the CD database and obtains the CD title, the name(s) of the artist(s), the track list and other information. Such information obtained from the database can also be referred to as “descriptive information” associated with the audio data stored on the CD. The descriptive information is recorded in an index table in another area of HDD 4 and associated with recorded audio data.

The audio data from the CD is sent to Codec 15 through IF 3 and bus 1. As an example, the CD audio data can be 16-bit linear. The original rate can be 1.2 megabits per second (Mbps). CD drive 2 may have, for example, an N-time fast playback capability. As such, the actual data rate would be N×1.2 Mbps. For 8-time fast playback, the actual data rate would be 9.6 Mbps. Thus, it would take about 8 minutes to record a 64-minute CD. Codec 15 encodes the 9.6 Mbps of data using memory 14.

Various encoding techniques or encoding standards may be used for encoding the data. For example, ATRAC3™ by Sony Corporation of Tokyo, Japan may be used for-encoding. Encoded data is sent to HDD 4 and stored through Bus 1 and a second interface 5. In one embodiment, the encoded data may be compressed to 1/10, for example. Thus, the encoded data rate is 960 kilobits per second (kbps).

The user can store an analog source, for example, cassette tape music or LP record music to HDD 4 using audio input 27. The analog signal undergoes analog-to-digital conversion by A/D 16 and is then sent to Codec 15. Codec 15 encodes the signal and sends the encoded signal to HDD 4 through Bus 1 and IF 5.

2. User Interface

A liquid crystal display (LCD) 7 or some other user-friendly device (e.g., touch screen GUI, etc.) may be used on server 201. Such an interface allows a user to file the audio data in a number of ways in order to facilitate easy finding of the audio tracks. Folders and sub-folders can be created. For instance, in filing a 1970 CD by a rock group named XYZ, the user can put this CD under a number of categories for future search and retrieval: rock, 1970, XYZ, or any category description the user would like to use.

The user interface 7 would also allow for easy entry such as an LCD touch screen or an icon-based GUI that uses drag and drop Windows™.

3. Data Stream Transmission

In one embodiment, data stream transmission can be performed as follows. CPU 6 obtains the index table in HDD 4 through IF 5 and Bus 1 and sends it to LCD 7 through Bus 1 and a third interface 8. LCD 7 may be, for example, a 40-character by the 20-line display. The user selects a CD title or a song name from the index list displayed on LCD 7 using a remote commander 9 or a key pad 24. In particular, a fourth interface (IF) 10 receives an infrared signal from remote commander 9 and sends it to CPU 6 through Bus 1. Alternatively, a fifth interface (IF) 23 receives a command from key pad 24 and sends it to CPU 6 through Bus 1. CPU 6 obtains the CD title or the song name selected by the user and sends the commands to HDD 4 to read the associated stream and to send it to PLC IF 12.

To keep packet intervals, each data packet in the stream is time-stamped when it arrives PLC IF 12 (Not shown). PLC IF 12 sends the audio stream to the clients through power plug 11 and power line 200 (shown in FIG. 1). In this example, it is noted that the stream rate may be 120 kbps.

Alternatively, it is more usual that a client (e.g., client 202) specifies a CD title or a song through power line 200. PLC IF 12 receives the information and sends to CPU 6. CPU 6 commands HDD 4 to send the stream out as described above.

In one embodiment, HDD4 and Bus 1 have enough data bandwidth to record a CD and to simultaneously send several audio streams to PLC IF 12. While sending the stream, the user can monitor it if he or she wants. The stream from HDD 4 is sent to Codec 15 and decoded. The result undergoes digital-to-analog conversion by D/A converter 19. The output analog signal is amplified by an amplifier (Amp) 20 and sent to loudspeaker 21 or audio output 28. Also, while sending the stream, the user can listen to another music. HDD 4 sends out another stream to Codec 15 and processes in the same way. If Codec 15 can encode and decode simultaneously, the user can listen to music from loudspeaker 21 while recording another CD to HDD 4.

When two or more clients receive and decode the same audio source, background music for example, transmission delay will be an issue because a user may detect the delayed sound as an echo, if the decoding time at each client exceeds a predetermined threshold. To avoid this, the total transmission delay is defined below a threshold time period, for example, less than 20 milliseconds. The buffer sizes of server 201 and clients 202 and 203 are chosen to meet this requirement.

4. CD Database Update

In one embodiment, the CD database in HDD 4 can cover a larger number of CDs (e.g., more than 80,000 CDs). There are two ways to update the database for new CD releases. One is to provide an update CDROM to the user. The other is an on-line update. As shown in FIG. 1, modem 204 is connected to transmission medium 205. In order to perform an on-line update, server 201 communicates with modem 204 through power line 200 and downloads the updated data from the targeted web site over transmission medium 205.

5. Downloading Music from a computer

A user may purchases music data (e.g., CDs) using a computer (e.g., PC, laptop, personal digital assistant, or any device with data processing capability). If the computer (not shown) is connected to power line 200, server 201 can download music data from the computer.

6. Memory Card Interface

In one embodiment, a memory card 26 (e.g., SONY®

MEMORY STICK®) can be used to exchange audio data with another device, for example, portable stereo gear (e.g., MEMORY STICK® Walkman). The audio data stored in memory card 26 is sent and stored to HDD 4 through a sixth interface (IF) 25, Bus 1 and IF 5. In reverse, the user also can download audio data in HDD 4 to memory card 26. In one embodiment, the user can control all the operations using remote commander 9 or key pad 24.

7. Intercom

In one embodiment, server 201 can send a voice signal to a client (e.g., client 202). As such, the system as shown in FIGS. 1 and 2 can function as an intercom system. In this configuration, a microphone 18 receives the voice signal in an analog format. This signal undergoes analog-to-digital conversion by A/D 16 and is sent to Codec 15. Codec 15 encodes the signal, which is sent to PLC IF 12 through Bus 1. PLC IF 12 sends the signal to the client (e.g., Client 202) through power line 200. The voice signal from Client 202 is received by PLC IF 12 and sent to Codec 15 through Bus 1. The signal is decoded, undergoes digital-to-analog conversion by D/A 19, is amplified by amplifier (Amp) 20 and sent to loudspeaker 21.

B. Client

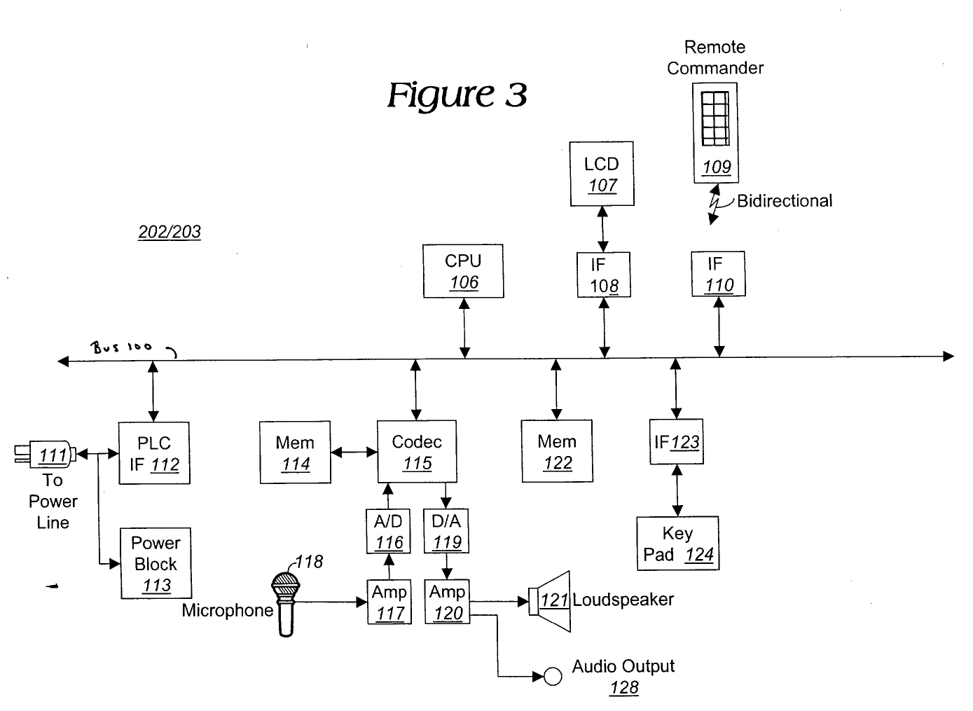

FIG. 3 shows a block diagram of an exemplary client (e.g., Client 202 in FIG. 1). Most of the components shown in FIG. 3 are also deployed in server 201 (which is shown in FIG. 2). For a cost-saving thin client, some components can be removed and some components can use less expensive parts. In one embodiment, CPU 106 is slower than CPU 6. Memory 122 is smaller than memory 22. Also, LCD 107 may be smaller than LCD 7 (ex. 20-character by 4-line). CPU 106 controls all the components. Microphone 118, Amp 117 and A/D 116 work in the same way as Microphone 18, Amp 17 and A/D 16 that are shown in FIG. 2.

In one embodiment, for easy operation, remote commander 109 may have a LCD display. With this type of remote, the user does not have to get close to the client device to see the LCD display (e.g., LCD 107) on the client.

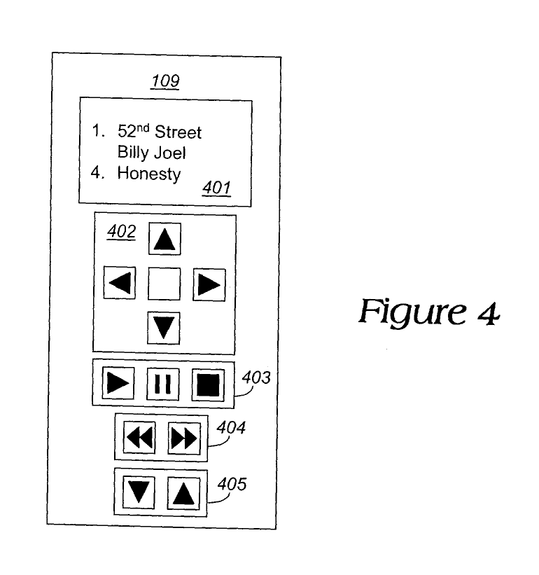

FIG. 4 shows an example of remote commander 109 with a LCD display. As shown in FIG. 4, LCD display 401 shows a CD title and a track. Cursor buttons 402 are used to select a title and a track. For example, the up and down buttons can be used to select a title or a track. By pushing the left or the right button, the next title or the next track is shown one after another. Buttons 403 are for “Play”, “Pause”, and “Stop”. Buttons 404 are for “Fast Review” and “Fast Forward”. Buttons 405 are for volume adjustment.

In this example, CPU 106 sends the title and track data to interface (IF) 110 through Bus 100. The data is sent to remote commander 109 as an infrared (IR) signal and shown on display 401. In order to accelerate display response time, remote commander 109 may have enough memory to store in advance part or whole of the title/track information in server 201. If not, remote commander 109 obtains a title and a track data from server 201 each time the user selects. Display 401 also shows titles and tracks of on-going streams from server 201 to another client. By selecting one of the streams, the user can listen to the same music at the same time as in the other room.

1. Data Stream Reception

In one embodiment, data stream reception can be performed as follows. CPU 106 sends an information request (e.g., a title index data request) to server 201. The request is sent to PLC IF 112 through Bus 100 and then sent to server 201 over power line 200. Server 201 returns the index data to client 202. The index data is stored memory 122 through PLC IF 112 and Bus 100 and finally displayed in LCD 107 through interface 108. The user selects a title or a song from the index data displayed on the LCD 107 using remote commander 109 or key pad 124. CPU 106 obtains the selected music (e.g., title or song name) and sends to server 201 through power line 200. In response to the received music information, server 201 routes an audio data stream over power line 200. PLC IF 112 of client 202 receives the data stream and sends each data packet in the stream to Codec 115 through Bus 100 at the timing based on its time stamp.

Codec 115 decodes the stream using memory 114. The result undergoes digital-to-analog conversion by D/A 119, amplified by Amp 120 and sent to loudspeaker 121 or audio output 128.

2. Encryption

Usually, several neighbors share power line 200. Therefore, data encryption may be required for security and privacy. Also, data encryption may be necessary for content protection. Various schemes or standards of data encryption/decryption may be used. In one embodiment, the system as described herein is configured to support symmetric key cryptography such as cryptography in accordance with Data Encryption Standard (DES). Information about DES can be obtained from “Applied Cryptography” by Bruce Schneier (published by John Wiley & Sons, ISBN 0-471-11709-9).

Server 201 and clients 202 and 203 in the home, e.g., in the same network, share a common key. In one embodiment, all communications are encrypted with the common key, although it is contemplated that encryption may be reserved only for security-sensitive information. Since a device in a neighbor's network does not have access to the common key, it cannot decrypt the communications.

For one embodiment, server 201 generates the common key. Each client has a unique identifier (referred to as a “client ID”). In order to add a client (e.g., client 202) to the network, the user enters its unique client ID into server 201 via key pad 24, memory card 26 or another input device. Server 201 encrypts the common key with the unique client ID and sends the encrypted common key back to client 202. Client 202 decrypts the encrypted common key with its own client ID and retrieves the common key. Without this key registration, no client can access to the network.

In one embodiment, PLC IF 12 of server 201 and PLC AF 112 of client 202 include DES encryptor and decryptor (not shown in FIGS. 2 and 3). In server 201, the common key is stored in memory 22 and CPU 6 reads it. To add client 202 to the network, the client ID is entered from key pad 24 and it is also stored in memory 22. CPU 6 encrypts the common key with the client ID. The result is sent to client 202.

The common key is set to the encryptor in PLC Interface 12 of client 202. Therefore, communications are encrypted with the common key.

In client 202, the encrypted common key sent from server 201 and is stored in memory 122. The client ID is stored also in memory 122. CPU 106 decrypts the encrypted key with the client ID and obtains the original common key. The common key is set to the decryptor in PLC Interface 112 and the decyrptor decrypts encrypted communications from server 201 or from other clients such as client 203.

It is not easy for an average user to enter each client ID to server 201. Usually, a client ID is a 10-digit or longer combination of numbers and characters. There are three ways for easy client ID input.

First, client 202 features a memory card (e.g., memory card 26 of FIG. 2) that stores its ID. The user couples the memory card to memory card IF 25 of server 201. CPU 6 reads the client ID from the memory card and stores it into memory 22. This may be the most user-friendly entry procedure, but client 202 and the memory card need to be “paired” in the factory.

Second, the user temporarily connects audio output 128 of client 202 to audio input 27 of server 201 before client installation. The client ID is sent as an audio signal from client 202 to server 201. The audio signal is, for example, a sequence of pulses which a conventional pulse-dialing phone uses. CPU 106 receives a request from key pad 124 and generates the client ID signal and sends it to D/A 119 through Codec 115. The signal undergoes digital-to-analog conversion by D/A 119, is amplified by Amp 120 and sent to audio output 128. The signal is input into audio input 27, amplified by Amp 17 and undergoes analog-to-digital conversion by A/D 16. CPU 6 decodes the signal and obtains the client ID.

If CPU 6 successfully obtains the client ID, a message is sent to LCD 7 and displayed. After the client ID is entered, the user disconnects the audio cable and installs client 202 wherever he/she wants. The client ID may be sent several times to avoid errors. Also, the signal may include a cyclic redundancy code, with which server 201 detects an error.

Third, the remote commander 109 of client 202 stores the client ID. The user points it at IF 10 of server 201 and pushes the button. The client ID is sent as an IR signal. It is received by IF 10 and sent to CPU 6. For such functionality, client 202 and remote commander 109 should also be paired in the factory. If remote commander 109 supports bi-directional IR communications, the client ID does not have to be factory-set. CPU 106 of client 202 sends the client ID to remote commander 109 through IF 110. Remote commander 109 temporarily stores the client ID. The user points it at IF 10 of server 201 and pushes the button, which causes the client ID received by IF 10 to be routed to CPU 6 or memory 22.

3. Transmission Error Recovery

In one embodiment, the system has two transmission modes; namely, normal mode and robust mode. An error correction code is added to audio data in PLC Interface 12 before transmission. The audio data is error-corrected in PLC Interface 112 if an error occurs during transmission.

In normal mode, server 201 keeps on sending a stream regardless of transmission error. When an uncorrectable error occurs, a client (such as Client 202) stops decoding and mutes the output in order to mitigate noise until the transmission recovers from the error. The normal mode is used when there is not enough bandwidth. Robust mode is used to make transmission more reliable. It requires more bandwidth than the normal mode.

When an uncorrectable error occurs, client 202 returns an error message to server 201. Server 201 sends the same data again to client 202. In one embodiment, compressed audio data rate is 100-300 kbps while current PLC data rate is around 5 Mbps. As such, even if the system is operated in robust mode, there is enough bandwidth for several streams.

4. Prioritization

In one embodiment, when server 201 sends several streams to several clients, priority of each stream can be controlled so that server 201 can evenly output all the streams. For example, when an error often occurs in one of the streams, priorities are controlled so that the unstable stream gets higher priority. For instance, server 201 may send the first stream to client 202 and the second stream to client 203 concurrently or even simultaneously. The transmission condition from server 201 to client 202 is very good and the first stream is almost error-free. On the other hand, communication between server 201 and client 203 is poor for some reason (e.g., noise, etc.) and an error frequently occurs in the second stream.

In this case, re-sending request from client 203 can be given priority over the first stream transmission. In one embodiment, server 201 obtains transmission condition of each stream from frequency of re-sending requests. Server 201 controls the priorities so that the most erroneous stream has the highest priority.

5. Alarm Capability

In one embodiment, clients in the system such as client 202 include an alarm capability. The user sets the music title and the time using remote commander 109 or key pad 124. When the time comes, client 202 sends commands to server 201 and asks server 201 to send the music to the client. Alternatively, client 202 may send the music title and the time to server 201 just after the user inputs. Server 201 holds the alarm information, and when the time comes, server 201 begins to send the data to client 202. In this configuration, each client can set different music title and time independently.

6. Intercom Capability

As described herein, each server 201 and client (e.g., client 202) has a microphone. They can work as an intercom system. For example, assuming that the first user is at server 201 and calls the second user near client 202. The user specifies the destination (client 202) and pushes the call button on key pad 24. The signal goes to client 202 and makes it beep. Server 201 and client 202 are set to intercom mode. Audio decoding is temporarily muted.

The first user's voice is received by microphone 18, encoded and sent to client 202. Client 202 decodes the voice signal. The second user's voice is processed and sent to server 201 in the same way. If Codec 15 and Codec 115 simultaneously encode and decode the voice signal, both users can talk and listen at the same time (full duplex communication). If not, they can talk or listen (half duplex communication). Peer-to-peer encryption can be applied to prevent eavesdropping. In case of broadcasting, the user specifies all the other devices as destination. The talker's voice is broadcast to all the devices.

### II. Method of Operation

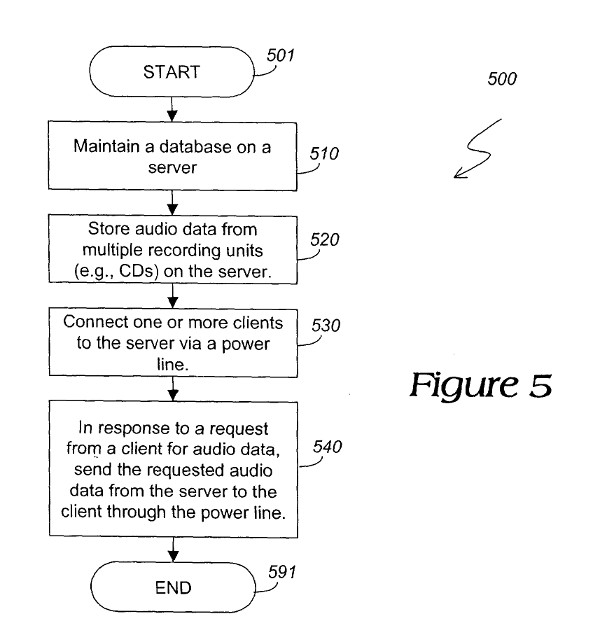

FIG. 5 illustrates a flow diagram of a method according to one embodiment of the present invention. At block 510, a database is maintained on a server. In one embodiment, as described above, the database is used to store information associated with audio data recorded on recording units. For example, the database can be used to store title, author, content list, and other information associated with various CDs. At block 520, audio data from multiple recording units (e.g., CDs) are stored on the server. At block 530, one or more clients are connected to the server via a power line. In this configuration, the server and the clients communicate via the power line through a power line communication interface (PLC).

At block 540, in response to a request from a client for some specific audio data, the server sends the requested audio data to the client through the power line via the PLC.

In one embodiment, the following features can be implemented to enhance the capacity and capabilities of the system as described herein. For example, a very high speed PLC (e.g., 20 Mbps or higher) can be used for robust transmission. A high capacity HDD (e.g., 100 GB or larger) may be used to increase storage capacity for the system which can hold data for thousands of CDs. In addition, a high speed recording device (e.g., 32× or higher CD drive) in the server can be used to speed up the storing of audio data to HDD. Automatic CD changer can also be used for storing audio data from CDs to HDD. Similarly, each client may have a CD drive to remote-record or remote-store audio data from the client to the server. Large high resolution LCDs can also be used for the user interfaces.

It should be understood and recognized by one skilled in the art that other variations of the invention can be implemented within the scope of the invention. For example, multiple server configuration and operation can be implemented in which two or more servers can be connected to the power line. From a client, the user can select a server. Then, the index data of the music or audio data stored in the selected server is displayed to the user. The user the selects a CD title or a song. In this configuration, audio exchange is available between the servers. Furthermore, a server in the system can function as a video server. For example, if the PLC is faster the HDD is larger, the system can handle video data. In another variation, the client may have wireless interface for a wireless headset. It can receive data and emit to the headset. In this configuration, the user can quietly enjoy the music without cable. In yet another variation, very inexpensive simple clients without input functions can be used. This type of low-cost clients only decodes the stream from the server. No microphone, no remote, no LCD and no keypad are implemented. It is mainly for background music systems. In this configuration, the server controls all other functions as described above.

As described herein, embodiments of the present invention provide a PLC-based network audio system that includes several capabilities and functions. Again, there is no new wiring required. Existing power lines can be used for data transmission between servers and clients. A user of the system can listen to any music or audio data stored in a server from any power outlet in the house or in the building. Inexpensive thin clients can be used in the system. The system according to the teachings of the present invention is highly expandable. More servers or clients can be easily added to the system. As mentioned above, a user can listen to or send a stream while recording a CD to the server. Data encryption capabilities protect contents and privacy. In addition, as discussed above, the system provides error robustness in which data is re-sent when an error occurs. Moreover, the system also provides for prioritized transmission based on error condition, as described above. The system can be connected to a computer through the power line. The system can be connected to a able or xDSL modem for external network access (e.g., Internet access). Furthermore, the system also includes alarm capability and intercom capability.

While the invention has been described in terms of several embodiments, those of ordinary skill in the art will recognize that the invention is not limited to the embodiments described herein. It is evident that numerous alternatives, modifications, variations and uses will be apparent to those of ordinary skill in the art in light of the foregoing description.

What is claimed is:

1. A system comprising:
a server to store audio data recorded on multiple recording units and corresponding information associated with the respective audio data, the audio data recorded on each recording unit being identified by a unique identifier, the unique identifier being used to obtain and associate the corresponding information with the respective audio data; and
one or more clients coupled to the server via one or more power lines, the one or more clients to access the server via the one or more power lines to download audio data and the corresponding information associated with the audio data from the server.

2. The system of claim 1 wherein the corresponding information associated with the audio data is selected from the group consisting of title of the audio data, author of the audio data, content listing of the audio data, and titles of audio works contained in the audio data.

3. The system of claim 1 wherein the server is connected to the one or more power lines via a power line communication (PLC) interface.

4. The system of claim 1 wherein the server includes a hard disk drive (HDD) to store the audio data and the corresponding information.

5. The system of claim 4 wherein the corresponding information for the audio data is stored in a database.

6. The system of claim 5 wherein the corresponding information is stored in an index table in the database.

7. The system of claim 5 wherein the server, upon obtaining a unique identifier of a respective recording unit of the multiple recording units, queries the database to obtain information associated with the audio data recorded on the one of the respective recording unit, the information being at least a portion of the corresponding information.

8. The system of claim 7 wherein the audio data from the respective recording unit is encoded and stored on the hard disk drive of the server.

9. The system of claim 1 wherein the server, upon receiving a request from a client of the one or more clients coupled to the server via the one or more power lines, transmits the requested audio data to the client through the one or more power lines.

10. The system of claim 5 wherein the database containing the corresponding information is updated via the Internet to obtain information regarding new releases of audio data.

11. The system of claim 5 wherein the database containing the corresponding information is updated via a CDROM.

12. The system of claim 1 wherein the server and the one or more clients are equipped with intercom capability to allow users of the system to use the system as an intercom.

13. The system of claim 1 wherein the server operates in a first transmission mode in which the server keeps on sending a data stream regardless of transmission error and the client, in response to an error, stops decoding and muting its output until the transmission recovers from the error.

14. The system of claim 1 wherein the server operates in a second transmission mode in which the server sends a block of data packets to a client and waits until the client confirms that there is no error with the data packets before the server sends the next block of data packets.

15. The system of claim 14 wherein, in response to an error message from the client, the server re-sends the same block of data packets to the client.

16. The system of claim 1 wherein the server sends multiple streams to multiple clients concurrently and wherein priority of each stream is controlled by the server.

17. The system of claim 16 wherein a stream with higher transmission error is given higher priority relative to other streams.

18. The system of claim 1 wherein each of the one or more clients includes alarm capability to allow a client to specify when the client wants to receive certain audio data from the server.

19. The system of claim 1 further including a remote commander with visual display to allow a user of the client to view information displayed on the client remotely.

20. The system of claim 19 wherein the visual display of the remote commander is used to display information associated with audio data including title of the audio data.

21. A method comprising:
maintaining a database on a server, the database containing information associated with audio data recorded on recording units;
storing audio data from multiple recording units on the server;
establishing communications between the server and one or more clients over a power line via a power line communication interface; and
in response to a request for audio data, sending the requested audio data from the server over the power line.

22. The method of claim 21 further comprising:
upon obtaining a unique identifier of each recording unit of the multiple recording-units, querying the database to obtain information associated with the audio data recorded on the respective recording unit; and
maintaining an index table to associate the information from the database with the audio data stored on a hard disk drive of the server.

23. The method of claim 22 further comprising:
in response to an index data request from the one or more clients, sending the requested index data from the server to the one or more clients via the power line; and
displaying the index data on a first display device.

24. The method of claim 23 further comprising:
in response to a first user's selection of one or more index entries displayed, sending a request for audio data corresponding to the selected entries to the server.

25. The method of claim 21 wherein the database is updated via the Internet.

26. The method of claim 21 wherein the database is updated using a CDROM.

27. The method of claim 21 wherein the server and the one or more clients are equipped with intercom capability.

28. The method of claim 21 wherein the server operates in a first transmission mode in which the server keeps on sending a data stream regardless of transmission error and the client, in response to an error, stops decoding and muting its output until the transmission recovers from the error.

29. The method of claim 21 wherein the server operates in a second transmission mode in which the server sends a block of data packets to a client of the one or more clients and waits until the client confirms that there is no error with the data packets before the server sends the next block of data packets.

30. The method of claim 21 wherein the server sends a plurality of data streams to at least two clients and wherein priority of each stream is controlled by the server.

31. The method of claim 30 wherein a stream with higher transmission error is given higher priority relative to other streams.

32. The method of claim 21 wherein a client of the one or more clients includes alarm capability to allow the client to specify when the client wants to receive certain audio data from the server.

33. The method of claim 21 wherein a remote commander with visual display is used by a user of a client of the one or more clients to view information displayed on the client remotely.

34. A machine-readable medium comprising instructions which, when executed by a machine, cause the machine to perform operations, comprising:
maintaining a database containing information associated with audio data recorded on recording units;
storing audio data from multiple recording units;
establishing a connection to communicate with at least one client via a power line; and
in response to a request for audio data from the client, sending the requested audio data to the client through the power line.

35. The machine-readable medium of claim 34 wherein the operations performed by the machine further including:
upon getting a unique identifier of each recording unit, querying the database to obtain information associated with the audio data recorded on the respective recording unit; and
maintaining an index table to associate information from the database with stored audio data.

36. The machine-readable medium of claim 35 wherein the operations performed by the machine further including:
in response to an index data request from the client, sending the requested index data to the client via the power line; and
displaying the index data on a first display device.

37. The machine-readable medium of claim 34 wherein the database is updated via the Internet.

38. The machine-readable medium of claim 34 wherein the machine is a server.

39. A server adapted to a power line along with a client, comprising:
means for coupling the server to the power line; and
means for storing both audio data recorded on multiple recording units and information associated with the respective audio data, the audio data recorded on each recording unit being encrypted with a key shared with the client via a unique identifier associated with the client.

40. The server of claim 39, wherein the unique identifier is loaded into the server via an input device and the key is provided to the client by encrypting the key with the unique identifier.

41. The server of claim 39, wherein the unique identifier is loaded into the server by coupling an output of the client to an input of the server and sending the unique identifier as part of either a video signal or an audio signal.

42. The server of claim 39, wherein the unique identifier is loaded into the server by a remote commander of the client, the remote commander storing the unique identifier associated with the client as an infrared signal to an interface of the server.
